(19) United States
(12) Patent Application Publication
(10) Pub. No.: US 2025/0047386 A1
(43) Pub. Date: Feb. 6, 2025

(54) SYSTEM FOR DATA TRANSMISSION BETWEEN COMPONENTS OF A SEWER INSPECTION SYSTEM AND/OR SEWER MAINTENANCE SYSTEM

(71) Applicant: iPEK International GmbH, Sulzberg (DE)

(72) Inventor: Hannes Endler, Marktoberdorf (DE)

(21) Appl. No.: 18/735,762

(22) Filed: Jun. 6, 2024

(30) Foreign Application Priority Data
Jun. 6, 2023 (EP) 23177624.6

(51) Int. Cl. H04B 10/25; G06Q 10/20; H04B 10/40

(52) U.S. Cl. CPC H04B 10/2589; G06Q 10/20; H04B 10/40

(57) ABSTRACT

A system is provided for data transmission between a first component and a second component of a channel inspection and/or maintenance system, wherein coupling elements of the components can be connected to one another in such a way that, when the coupling elements are connected to one another, transceiver devices comprised by the two coupling elements can be operatively coupled, and wherein the two transceiver devices are each adapted to carry out an optical data transmission between them.

### CROSS-REFERENCE TO RELATED APPLICATIONS

This application claims priority to European Patent Application Serial No. EP23177624.6, filed Jun. 6, 2023, the entire disclosure of which is hereby incorporated herein by reference in its entirety.

### FIELD OF THE INVENTION

The invention relates to a system for data transmission between components of a sewer inspection and/or maintenance system, a correspondingly adapted coupling element, and a component of a sewer inspection and/or maintenance system.

### BACKGROUND OF THE INVENTION

In the area of sewer inspection and/or maintenance, additional components such as camera modules or other measuring modules that require a high data rate or bandwidth to typically be detachably connected to the feed unit (e.g. a carriage).

Camera units are usually equipped with a rotation-pan mechanism. Slip rings and plug contacts are usually used to transmit the signals or data from the camera to the feed unit.

Camera modules with 1k sensors deliver raw data rates of 1.5 to 3 Gbit/s. With a 4k camera module, the data rates quadruple to 12 Gbit/s. Other sensors such as high-resolution ultrasound scanners, LIDAR, etc. may also require high bandwidths for efficient data transmission.

Due to the limited number of plug contacts in conventional solutions, serial data interfaces with few data lines are preferably used. For example, LVDS (Low Voltage Differential Signaling) via Serializer/Deserializer, CoaxPress, Cameralink, USB 3.0, Single-Pair Ethernet, GigE Vision, SDI, enable data rates of up to 10 Gbit/s.

However, conventional analog video interfaces are also sometimes used.

The first-mentioned digital interfaces have increased requirements for the connectors or rotary feedthroughs due to the high bandwidth. The connectors then usually have to be coaxial or twisted pair. The robust plug contacts are not suitable for high data rates. In order to meet the requirements of explosion protection, air and creepage distances between the plug contacts are for example necessary, which however, have a negative effect on the signal integrity.

Another solution approach known from the state of the art is that the data rate is already reduced by compression methods before transmission via a slip ring or plug contact. However, compressing high-resolution videos requires powerful video processing units, which require space and, due to their performance, require a cooling design. In most cases, the available space in the additional components (camera, etc.) is not sufficient to integrate a processor module, an FPGA, or the like.

It is also possible to transmit the data wirelessly via electromagnetic waves. Inductive near-field communication or a radio standard (WiFi) is used here. Both transmission options have a limited bandwidth.

### OBJECT OF THE INVENTION

The object of the present invention is therefore to provide a system for data transmission between components of a sewer inspection and/or maintenance system, which at least partially avoids the disadvantages mentioned and can nevertheless be designed robustly and ensures a high bandwidth for data transmission between the components.

### SUMMARY OF THE INVENTION

This object is achieved by a system, a coupling element, and a component according to the independent claims. Advantageous embodiments are specified in the corresponding dependent claims.

Accordingly, a system is provided for data transmission between a first component and a second component of a sewer inspection and/or maintenance system, wherein
the first component comprises
a first coupling element and
a first transceiver device,
   wherein the first coupling element comprises the first transceiver device,
the second component comprises
a second coupling element and
a second transceiver device,
   wherein the second coupling element comprises the second transceiver device,
   wherein the two coupling elements can be connected to one another in such a way that, when the coupling elements are connected to one another, the transceiver devices comprised by the two coupling elements can be operatively coupled, and
   wherein the two transceiver devices are each adapted to carry out an optical data transmission between them.

It is advantageous if the two transceiver devices are each adapted to carry out a bidirectional optical data transmission between them.

It can furthermore be advantageous if
the first coupling element comprises a first electrical interface and
the second coupling element comprises a second electrical interface which are adapted to carry out a transmission of electrical energy and/or data between the two components when the coupling elements are connected to one another. This makes it possible to carry out both optical data transmission and electrical energy transmission over a single connection.

It can be advantageous if the two electrical interfaces are adapted to carry out the transmission of electrical energy on an inductive basis.

In one embodiment of the invention, the two coupling elements can be connected to one another so as to be rotatable relative to one another about a common axis of rotation.

The transceiver devices can each have a transmitting and/or receiving optics arranged in the axis of rotation of the corresponding coupling element. This allows the coupling elements to be rotated relative to one another around the common axis of rotation without affecting the optical data transmission.

It can be advantageous if the two coupling elements are designed in such a way that, in the connected state, they form a largely gas- and fluid-tight volume between the two coupling elements for the transmission path of the optical data transmission between the two transceiver devices.

It can also be advantageous if the components are each designed to be gas- and fluid-tight, in particular if they are each arranged in a gas- and fluid-tight housing.

In one embodiment of the invention, the two transceiver devices can each be adapted
to convert received optical light pulses representing received data into an electrical signal representing the received data, and/or
to convert an electrical signal representing data to be transmitted into optical light pulses to be transmitted, which represent the data to be transmitted.

It is advantageous if the two coupling elements can be detachably connected to one another.

Also provided is a coupling element for a component of a sewer inspection and/or maintenance system, wherein the coupling element comprises a transceiver device, wherein the coupling element can be coupled to a further coupling element having a transceiver device, wherein the transceiver device is adapted to set up an optical data transmission to the transceiver device of the further coupling element.

The coupling element can comprise an electrical interface which is adapted to carry out a transmission of electrical energy and/or data with an electrical interface of the further coupling element.

The transceiver device can have a transmitting and/or receiving optics, wherein the transmitting and/or receiving optics is preferably arranged in an axis of rotation of the coupling element.

Finally, the invention provides a component of a sewer inspection and/or maintenance system, comprising a coupling element and a transceiver device, wherein the coupling element comprises the transceiver device, and wherein the transceiver device is adapted to carry out an optical data transmission.

The coupling element can comprise an electrical interface, wherein the electrical interface is adapted to transmit electrical energy and/or data.

The electrical interface can be adapted to transmit electrical energy on an inductive basis.

The transceiver device can comprise an optical interface adapted to transmit data.

The component of the sewer inspection and/or maintenance system can be, for example, a carriage, a camera, a manipulator, sensor systems. For example, a camera can be coupled to the carriage by means of the system according to the invention, and the data transmission can then be carried out on an optical basis.

### BRIEF DESCRIPTION OF THE FIGURES

Further details and features of the invention as well as specific, particularly advantageous embodiments of the invention are apparent from the following description in conjunction with the drawing. In the figures:

FIG. 1 shows two components of a sewer inspection and/or maintenance system according to the invention;

FIG. 2 shows an embodiment of coupling elements according to the invention in detail;

FIG. 3 shows a specific application example of the invention based on a rotatable and/or pivotable camera module of a sewer inspection and/or maintenance system;

FIG. 4 shows an alternative embodiment of two components of a sewer inspection and/or maintenance system according to the invention; and

FIG. 5 shows a further alternative embodiment of two components according to the invention of a sewer inspection and/or maintenance system.

### DETAILED DESCRIPTION OF THE INVENTION

The invention advantageously makes it possible to carry out data transmission between two connectable components of a sewer inspection and/or maintenance system with high bandwidths safely and efficiently. According to the invention, the two components each have a transceiver device which is adapted to carry out an optical data transmission between them. The components or the coupling elements of the components are designed in such a way that, when coupled together, high data rates are possible over short distances.

The exchange of energy between the components of a sewer inspection and/or maintenance system can take place via conventional plug contacts. In one embodiment of the invention, however, it is provided to achieve the transmission of electrical energy by means of inductive coupling.

In one embodiment of the invention, it can be provided to arrange the optical components of the transceiver devices in the axis of rotation of the coupling elements or the components. This allows the mechanical coupling of the two components to be made rotatable without thereby affecting the optical data transmission.

In the case of non-rotatable mechanical coupling, as can be provided in an alternative embodiment of the invention, the transceiver devices can also be placed outside the axis of rotation of the coupling elements or components.

Due to the optical data transmission over very short distances with coupled components, very high data rates are possible. At the same time, complex slip rings or the like can be dispensed with, at least if the optical components of the transceiver devices are arranged in the axis of rotation of the coupling elements or the components.

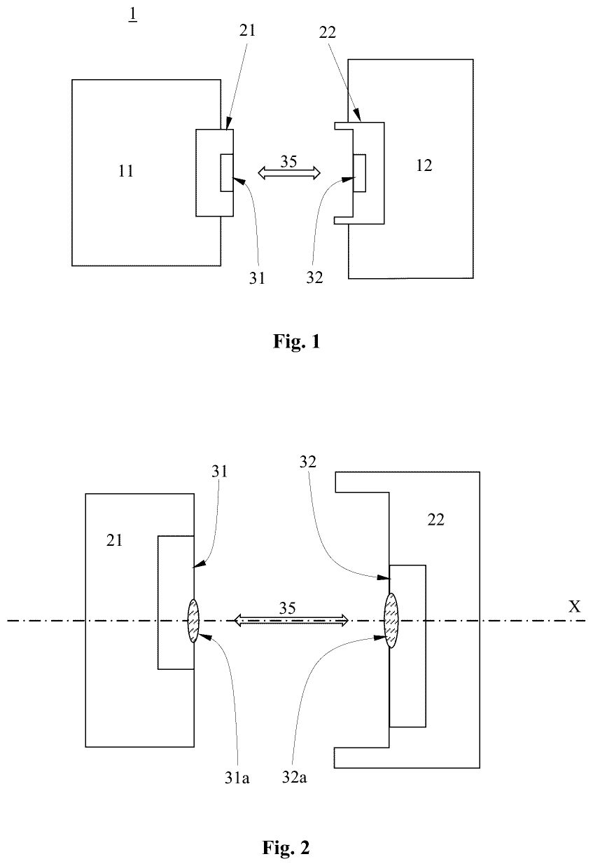

FIG. 1 shows a system 1 according to the invention with a first component 11 and a second component 12. The two components 11, 12 are components of a sewer inspection and/or maintenance system which can be coupled with each other and between which a data transmission is to be carried out.

The first component 11 has a first coupling element 21 and a first transceiver device 31, wherein the first coupling element 21 comprises the first transceiver device 31. The second component 12 has a second coupling element 22 and a second transceiver device 32, wherein the second coupling element 22 comprises the second transceiver device 32.

The two coupling elements 21, 22 can be connected to each other. In one embodiment of the invention, the two coupling elements 21, 22 can also be detachably connected to one another. The two coupling elements 21, 22 can in any case be connected to one another in such a way that, when the coupling elements 21, 22 are connected to one another, the transceiver devices 31, 32 comprised by the two coupling elements 21, 22 can be operatively coupled. “Can be operatively coupled” in this context means that when the two coupling elements are coupled together, the two transceiver devices are capable of being coupled in the sense of data transmission, i.e. they can be coupled in order to carry out an optical data transmission between them. The optical data transmission is illustrated in FIG. 5 by the double arrow 35. Both unidirectional and bidirectional optical data transmission between the two transceiver devices 31, 32 are possible.

In one embodiment of the invention, the two components 11, 12 are preferably each housed in a gas-and fluid-tight housing.

In a further embodiment of the invention, the two coupling elements 21, 22 can be designed such that, when they are coupled to one another, a gas- and fluid-tight volume or a gas- and fluid-tight space is formed between them, wherein the two transceiver devices 31, 32 are arranged in this volume or space. This can be achieved, for example, with a radially circumferential seal. This prevents dirt from getting between the two transceiver devices 31, 32 during operation, which could negatively affect the optical data transmission. In one embodiment, the space between the two transceiver devices 31, 32 is only protected against penetrating dirt that could negatively affect the optical data transmission.

The first component 11 can be, for example, a camera module and the second component 12 can be, for example, a carriage of a sewer inspection system. By means of the two coupling elements 21, 22, the camera module can be connected to the carriage so that a transmission of image and/or video data can be carried out via the two transceiver devices 31, 32.

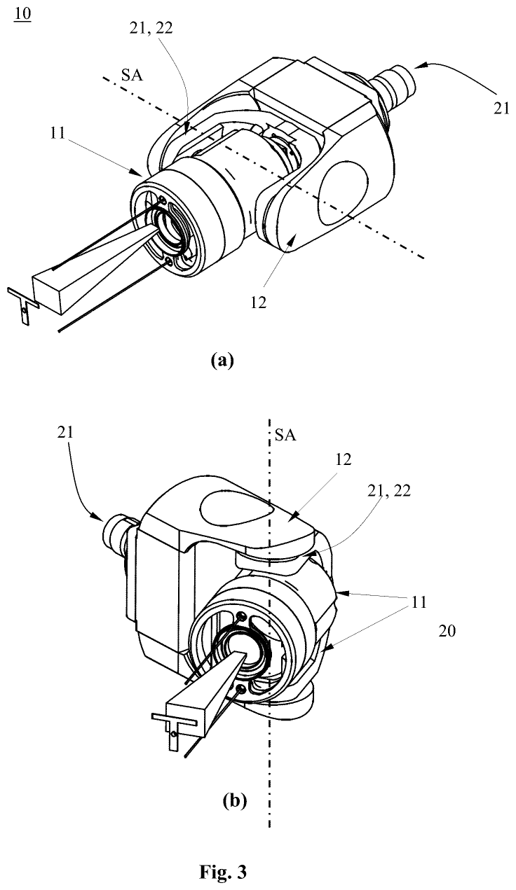

To lock the first component to the second component, appropriate locking means (not shown here) can be provided. In an advantageous embodiment of the invention, the locking means can be designed in such a way that they prevent an unintentional detachment of the first component from the second component, but nevertheless enable a rotation of the first component about an axis of rotation relative to the second component, as shown in FIG. 2.

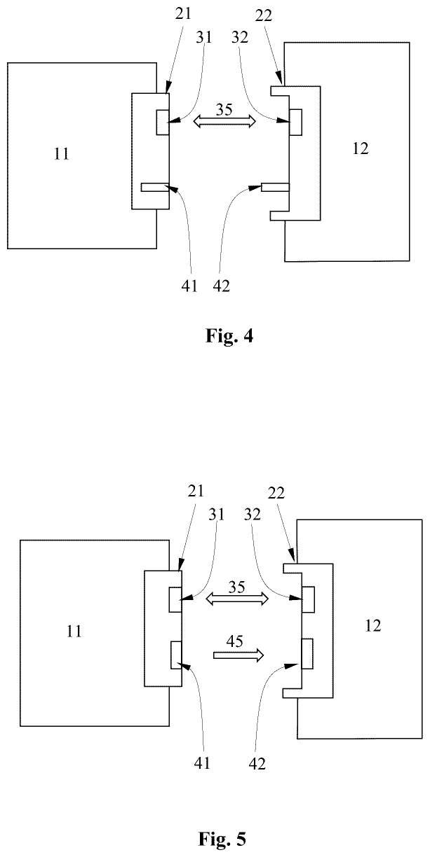

If the camera module has an integrated power supply (e.g. an accumulator or a battery), an external power supply, e.g. via the carriage or via the two coupling elements 21, 22, can be dispensed with. Embodiments according to the invention in which a power supply can be carried out via the two coupling elements 21, 22 are shown in FIG. 4 and FIG. 5.

FIG. 2 shows an enlarged view of the two coupling elements 21, 22 shown in FIG. 1. The two coupling elements 21, 22 shown in FIG. 2 are advantageous embodiments thereof which allow the coupling elements to be rotated relative to one another about an axis of rotation X without thereby affecting the optical data transmission. The two coupling elements 21, 22 can here be connected to one another so as to be rotatable relative to one another about a common axis of rotation X.

The two transceiver devices 31, 32 each have transmitting and/or receiving optics 31a, 32a (which are also present in the embodiments according to FIGS. 1, 3, 4, and 5, but are not shown there), which are arranged in the common axis of rotation X of the respective coupling element 21, 22. When the coupling elements 21, 22 are rotated about the axis of rotation X, the relative position of the two transmitting and/or receiving optics 31a, 32a does not change, so that an optical transmission 35 is ensured regardless of the angle of rotation.

The coupling elements 21, 22 are designed such that in the coupled state a predetermined distance is achieved between the two transmitting and/or receiving optics 31a, 32a, which distance is adapted to an optimal optical data transmission. For example, circumferential projections (not shown here) can be provided in the second coupling element 22 which prevent the distance between the two transmitting and/or receiving optics 31a, 32a from falling below a certain minimum distance when the two coupling elements are coupled. However, this can also be achieved by other means suitable for this purpose.

FIG. 3 shows a concrete application example of the invention using a rotatable and/or pivotable camera module of a sewer inspection and/or maintenance system 10.

The camera module has a camera head and a mounting fork for holding the camera head. The camera head here forms the first component 11 within the meaning of the invention. The mounting fork forms the second component 12 within the meaning of the invention.

The camera head 11 is arranged in the mounting fork 12 so as to be pivotable about a pivot axis SA relative to the mounting fork 12. This allows the viewing direction of the camera head to be changed as needed. Fig. (a) shows the camera head 11 in a first pivoting position, and Fig. (b) shows the camera head 11 in a second pivoting position.

The camera head 11 has a first coupling element 21 according to the invention, and the mounting fork 12 has a second coupling element 22 according to the invention. The coupling elements 21, 22 are arranged in the region of the pivot axis SA, so that the two coupling elements 21, 22 can be rotated relative to one another about the pivot axis SA. The two transmitting and/or receiving optics 31a, 32a of the coupling elements 21, 22 are each arranged in the pivot axis SA of the coupling elements 21, 22, so that pivoting of the camera head 11 relative to the mounting fork 12 has no influence on the optical data transmission.

The rear end of the mounting fork 12 can be rotatably connected for example to a lifting arm of a carriage. It has proven advantageous to also provide a first coupling element 21 there, which interacts with a second coupling element of the lifting arm. In this way, a continuous optical data transmission can be realized from the camera head 11, via the mounting fork 12, further via the lifting arm, to the carriage, without the need for sliding contacts or the like. Since the components can each also have their own power supply (accumulators or batteries), all coupling points (between camera head 11 and mounting fork 12, between mounting fork 12 and the lifting arm, and if necessary also between the lifting arm and the carriage) can also be realized completely wirelessly. If one of the components does not have its own power supply, only corresponding supply lines are required (as shown in FIG. 4). In an advantageous embodiment of the invention, however, the energy supply from the outside can also be carried out wirelessly or without cables (i.e. wirelessly between two components), as shown in FIG. 5.

FIG. 4 shows an alternative embodiment of two components of a sewer inspection and/or maintenance system according to the invention.

The embodiment according to FIG. 4 substantially corresponds to the embodiment of the invention shown in FIG. 1. In contrast to the embodiment shown in FIG. 1, the coupling elements 21, 22 here additionally have a first electrical interface 41 and a second electrical interface 42. The two electrical interfaces 41, 42 are designed here as a sleeve 41 or as a pin 42 corresponding to the sleeve 41. When the two coupling elements 21, 22 are coupled, the pin 42 engages with the sleeve 41 so that an electrical contact is created between them and a transmission of electrical energy can be carried out. Alternatively or additionally, data transmission can also be carried out via the electrical interfaces 41, 42.

It is also conceivable that further electrical interface pairs are provided so that the supply of power can be carried out via the first interface pair and data transmission can be carried out via the further interface pairs. For example, a system for data transmission between a first component 11 and a second component 12 of a sewer inspection and/or maintenance system can be provided, in which a data transmission that requires a high bandwidth is carried out via the optical interface, and a data transmission that only requires a low bandwidth is carried out via an electrical interface.

In addition to the bidirectional optical data transmission via the two transceiver devices 31, 32, the data transmission via the electrical interface can also be bidirectional.

FIG. 5 shows a further alternative embodiment of two components according to the invention of a sewer inspection and/or maintenance system.

The embodiment according to FIG. 5 substantially corresponds to the embodiment of the invention shown in FIG. 4. In contrast to the embodiment according to FIG. 4, in the embodiment according to FIG. 5 the two electrical interfaces 41, 42 are designed to be contactless or wireless. The two electrical interfaces 41, 42 are preferably adapted to carry out the transmission 45 of electrical energy on an inductive basis.

In the embodiments of the invention shown above, the transceiver devices 31, 32 can each be adapted to convert received optical light pulses representing received data into an electrical signal representing the received data and/or to convert an electrical signal representing data to be transmitted into optical light pulses to be transmitted which represent the data to be transmitted.

Above, a camera head was described as the first component within the meaning of the invention. However, the first component can also be a measuring module, an ultrasound module, a manipulator module, a second carriage part, an additional camera, a milling module, or a sensor module. Within the meaning of the present invention, any module that is used in sewer inspection and/or maintenance and to which data are transmitted or from which data are received can have a coupling element 21, 22 according to the invention in order to form a component 11, 12 according to the invention.

We claim:

1. A system for data transmission between a first component and a second component of a sewer inspection and/or maintenance system, wherein
the first component comprises:
a first coupling element, and
a first transceiver device,
wherein the first coupling element comprises the first transceiver device,
the second component comprises:
a second coupling element, and
a second transceiver device,
wherein the second coupling element comprises the second transceiver device,
wherein the first and second coupling elements can be connected to one another in such a way that, when the coupling elements are connected to one another, the first and second transceiver devices comprised, respectively, by the first and second coupling elements can be operatively coupled, and
wherein the first and second transceiver devices are each adapted to carry out an optical data transmission between them.

2. The system according to claim 1, wherein the first and second transceiver devices are each adapted to carry out a bidirectional optical data transmission between them.

3. The system according to claim 1, wherein;
the first coupling element has a first electrical interface; and
the second coupling element has a second electrical interface,
the first and second electrical interfaces being adapted to carry out a transmission of electrical energy and/or data between the first and second components when the first and second coupling elements are connected to one another.

4. The system according to claim 3, wherein the first and second electrical interfaces are adapted to carry out the transmission of electrical energy on an inductive basis.

5. The system according to claim 1, wherein the first and second coupling elements are connectable to one another so as to be rotatable relative to one another about a common axis of rotation (X).

6. The system according to claim 5, wherein the first and second transceiver devices each have transmitting and/or receiving optics which are arranged in the axis of rotation (X) of a respective one of the first or second coupling elements.

7. The system according to claim 1, wherein the first and second coupling elements are designed such that, in the connected state, they form a largely gas- and fluid-tight volume between the first and second coupling elements that serves as a path of transmission for optical data traveling between the first and second transceiver devices.

8. The system according to claim 1, wherein the components are each designed to be gas- and fluid-tight, and in particular are each arranged in a gas- and fluid-tight housing.

9. The system according to claim 1, wherein the first and second transceiver devices are each adapted:
to convert received optical light pulses representing received data into an electrical signal representing the received data, and/or
to convert an electrical signal representing data to be transmitted into transmittable optical light pulses which represent the data to be transmitted.

10. The system according to claim 1, wherein the first and second coupling elements are detachably connectable to one another.

11. A coupling element for a component of a sewer inspection and/or maintenance system, wherein the coupling element comprises a transceiver device, wherein the coupling element can be coupled to a further coupling element having a transceiver device, wherein the transceiver device is adapted to set up an optical data transmission to the transceiver device of the further coupling element.

12. The coupling element according to claim 11, wherein the coupling element comprises an electrical interface which is adapted to carry out a transmission of electrical energy and/or data with an electrical interface of the further coupling element.

13. The coupling element according to claim 11, wherein the transceiver device has transmitting and/or receiving optics, wherein the transmitting and/or receiving optics are preferably arranged in an axis (X) of rotation of the coupling element.

14. A component of a sewer inspection and/or maintenance system, comprising a coupling element and a transceiver device, wherein the coupling element comprises the transceiver device, and wherein the transceiver device is adapted to carry out an optical data transmission.

15. The component according to claim 14, wherein the coupling element comprises an electrical interface, wherein the electrical interface is adapted to transmit electrical energy and/or data.

16. The component according to claim 15, wherein the electrical interface is adapted to transmit the electrical energy on an inductive basis.

17. The component according to claim 14, wherein the transceiver device comprises an optical interface that is adapted to transmit data.
